(19) United States
(12) Patent Application Publication
(10) Pub. No.: US 2009/0302971 A1
(43) Pub. Date: Dec. 10, 2009

(54) Ortho-Mode Transducer

(76) Inventors: Uwe Rosenberg, Backnang (DE); Ulrich Mahr, Backnang (DE); Jurgen Ebinger, Aspach (DE)

Correspondence Address: COATS & BENNETT, PLLC, 1400 Crescent Green, Suite 300, Cary, NC, 27518, US

(21) Appl. No.: 12/162,388

(22) PCT Filed: Feb. 1, 2007
(86) PCT No.: PCT/EP07/50971

§ 371 Date: Nov. 20, 2008

(30) Foreign Application Priority Data
Feb. 3, 2006 (GB) 0602184.4

(51) Int. Cl. H01P 5/12; H01P 1/161

(52) U.S. Cl. 333/137; 333/21 A

(57) ABSTRACT

An ortho-mode transducer (100) comprising a first part (102) with a first port (106) for connecting a first rectangular waveguide (112) and a second port (108) for connecting a second rectangular waveguide (114). The signals in the two waveguides have orthogonal polarizations. The transducer also comprises a second part (104) with a third port (110)for connecting a common circular waveguide (116) in which the two orthogonal signals can be propagated. Symmetry axes of cross sections of the first and the second waveguides have orthogonal orientation. The first rectangular port (106) has its broad walls perpendicular to the circumference of the common circular waveguide (116) and the second rectangular port (108) has its broad walls alongside the circumference of the common circular waveguide. The first and second ports are connected to the third port in opposite positions via 90-degree bends (118, 120). In a coupling region a separating plate extends from a wall closing the common circular waveguide, wherein the separating plate is oriented perpendicular to the longitudinal axes of parts of the rectangular ports coupled to the common circular waveguide.

### FIELD OF THE INVENTION

The present invention relates in general to the field of waveguide devices and in particular to the field of ortho-mode transducers.

### BACKGROUND OF THE INVENTION

Ortho-mode transducer (OMT) is a device forming part of an antenna feed, which is used to combine or separate orthogonally polarized signals. In practice it is a three port waveguide device, where two of these ports are for transmitting signals dedicated to the orthogonal orientations and the third port is for connecting waveguide for transmitting combination of the two orthogonally polarized signals.

Different OMT types are known e.g. from J. Uher, et. al. ‘Waveguide Components for Antenna Feed Systems: Theory and CAD’, Artech House, Boston-London, 1993. All types that provide reasonable characteristics exhibit interface ports that extend in different planes having an alignment of 90 or 180 degree to each other. There have been only two (theoretical) principle types (see FIG. 3.8.12c and 3.8.13c in the above reference) that provide the interface ports in a same plane, but they are of a secondary importance due to their poor performance properties. Therefore, standard high performance OMT types as e.g. shown in FIG. 3.8.6 and FIG. 3.8.11 or in EP1 183 752 B1 can be used with additional waveguide hardware (bends and waveguide sections) to adapt the interface ports of both polarisations in one plane.

Another possibility is the use of a standard design as e.g. introduced in M. Ludovico et. al. ‘CAD and Optimization of Compact Ortho-Mode Transducers’, IEEE Transactions on Microwave Theory and Tech., vol 47, no. 12, Dec. 1999. Such a design can be manufactured in two symmetrical halves that also integrate bending and waveguide sections to adapt the interfaces in parallel in a same plane. The drawback of the latter solution is that the parting plane is through the interconnecting flanges which hamper the necessary sealing of the complete unit for the usual outdoor applications.

Hence, an improved ortho-mode transducer would be advantageous and in particular one that has good performance characteristics, compact size and is easy for manufacturing.

### SUMMARY OF THE INVENTION

Accordingly, the invention seeks to preferably mitigate, alleviate or eliminate one or more of the disadvantages mentioned above singly or in any combination.

According to the present invention there is provided an ortho-mode transducer comprising a first part with a first port for connecting a first rectangular waveguide adapted to serve a first linearly polarized signal and a second port for connecting a second rectangular waveguide adapted to serve a second linearly polarized signal. The first signal and the second signal are dedicated to orthogonal polarizations. The orthomode transducer also comprises a second part with a third port for connecting a common circular waveguide in which the two orthogonal, linearly polarized signals can be propagated. Symmetry axes of cross sections of the first and the second rectangular waveguides have substantially orthogonal orientation and the first rectangular port has its broad walls perpendicular to the circumference of the common circular waveguide and the second rectangular port has its broad walls alongside the circumference of the common circular waveguide whereas the first rectangular port is connected to the third port via a first 90-degree bend and the second rectangular port is connected at the opposite position to the third port via a second 90-degree bend. In a coupling region a separating plate extends from a wall closing the common circular waveguide, wherein the separating plate is perpendicular to the longitudinal axes of parts of the rectangular ports coupled to the common circular waveguide.

Further features of the present inventions are as claimed in the dependent claims.

The present invention beneficially allows for the interfaces for the orthogonal polarisations to be realised in one plane without any parting plane of the unit through the flange connections with preserving high performance properties and compact size of the device. The compact size, in turn, facilitates manufacturing. Sealing of the complete unit is easily performed by a single closed O-ring between the two milled parts, which is very advantageous for outdoor application of antenna-feed systems.

### BRIEF DESCRIPTION OF THE DRAWINGS

The present invention will be understood and appreciated more fully from the following detailed description taken in conjunction with the drawings in which:

FIG. 1 illustrates an ortho-mode transducer in accordance with one embodiment of the present invention;

FIG. 2 illustrates a first part of the ortho-mode transducer in accordance with one embodiment of the present invention;

FIG. 3 illustrates a second part of the ortho-mode transducer in accordance with one embodiment of the present invention.

### DESCRIPTION OF AN EMBODIMENT OF THE INVENTION

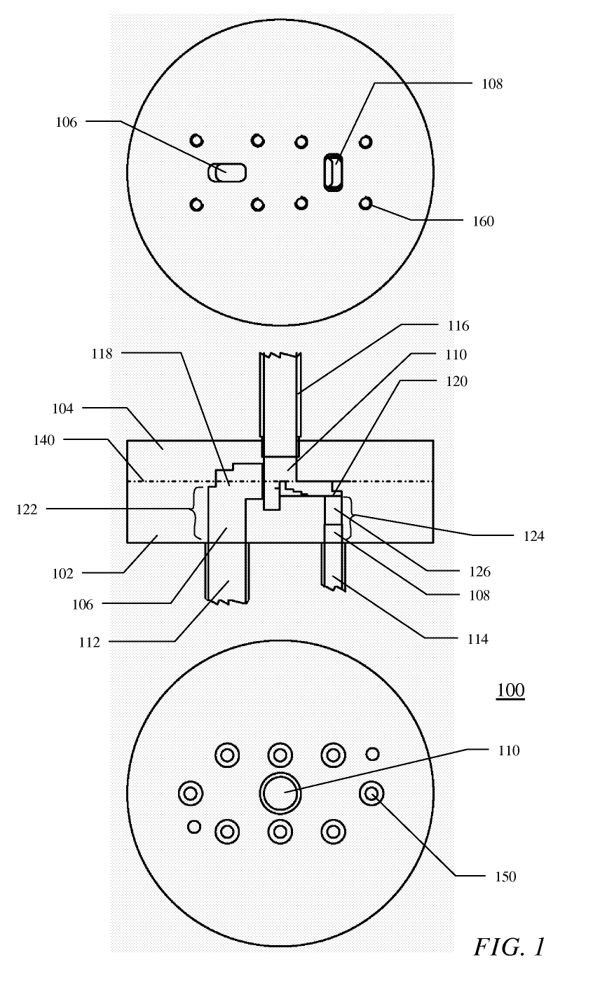

With reference to FIG. 1 an ortho-mode transducer is presented. For the sake of clarity the drawings present the invention in a very schematic way with elements and lines not essential for understanding the invention omitted.

The term “port” herein below refers to a part of a device, which allows for connecting a waveguide, but when the device is taken on its own the port functions as waveguide (waves are propagated inside the device), thus often when reference is made to a port it is meant to refer to the waveguide function of the port.

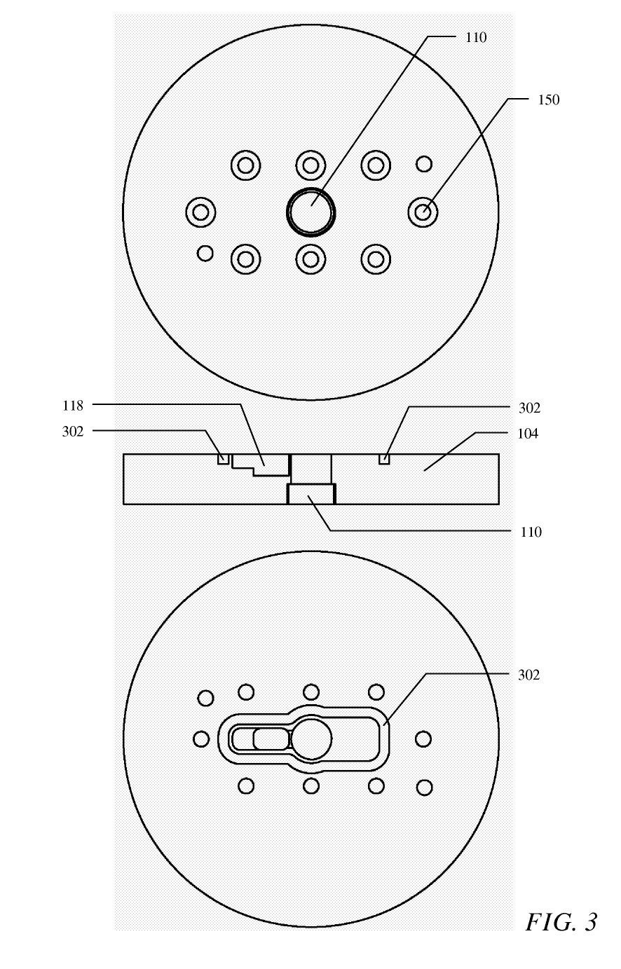

The principle of the invention is depicted in FIG. 1 through FIG. 3, which illustrate one of the plurality of possible embodiments of the present invention. The complete OMT 100 consists of two parts, 102 and 104, which can easily be realised by CNC milling techniques. A three-port branching region is used for the separation of the two polarisations. Two rectangular waveguides, a first rectangular waveguide 112 and a second rectangular waveguide 114, are facing the circumference of a common circular waveguide region at opposite positions. The cross sections of the rectangular waveguides 112 and 114 exhibit orthogonal alignment. Consequently there is no energy coupled from the first rectangular waveguide 112 across the circular waveguide section to the second rectangular waveguide 114. However, each waveguide 112 and 114 couple one of the decoupled orthogonal polarised TEl 1 modes of the circular waveguide 116. The circular waveguide 116 is short circuited at the end close to the junction whereas the other end extends towards the dual-polarised feeder of the antenna.

It should be noted that there is no plane short circuit at the end of the circular waveguide that extends towards the feeder (not shown in the figures). The use of different short circuit distances for certain regions of the circular cross section facilitates the realisation of the good performance properties (especially low reflection) for the separate orthogonal polarised signal paths.

The rectangular ports, first port 106 and second port 108, of the central three-port waveguide junction are associated with suitable integrated waveguide bends, 118 and 120 accordingly. The second rectangular port 108 of the junction having the broad walls in parallel to the circumference of the circular waveguide 116 is combined with an E-plane bend 120 while the first rectangular port 106 connects directly an H-plane bend 118. The bends 118 and 120, as in the embodiment depicted in FIG. 1, use stepped shapes to account for high performance properties (low return loss) while maintaining easy manufacturing by milling.

It is, however, in the contemplation of the present invention that not only stepped bends can be used in the OMT without departing from the inventive concept of the present invention.

In alternative embodiments, additional discontinuities as e.g. irises can be introduced between the junction and the bends for further improvement of the performance.

Due to the bending the first and second ports, 106 and 108, are obtained in a compact configuration with a parallel position in one plane.

It should be noted, that in alternative embodiments additional transformer sections can be introduced easily in the waveguide sections 122, 124 of the first and second ports 106, 108 facing the interfaces. This allows the adaptation of waveguides with other cross sections than the ones used at the three-port junction. Such a transformer section 126 is used at the second port 108, which is connected to the E-bend 120 to adapt the smaller waveguide size used for this path at the three-port junction.

A suitable parting plane 140 is chosen across the three-port junction for the favourable manufacturing of the unit 100 in two parts 102, 104. This parting plane 140 cuts the complete unit 100 at the upper broad wall of the second rectangular waveguide (of the second port 108), if looking from the two-port interface plane, which has its broad wall orientation along the circumference of the common circular waveguide 116. Thus, the first rectangular waveguide (of the first port 106) is cut nearly close to the center of its broad wall. Hence, the waveguide structure for the second waveguide is completely realised in the first part 102 of the OMT—the second part 104 completes with the flat plane the top wall. The structure of the first waveguide part is situated in both parts 102 and 104 of the unit 100—whereas the rectangular waveguide interfaces for both are in the first part 102. The second part 104 contains a third port 110 for connecting the common circular waveguide 116.

In one embodiment, in order to achieve easy interfacing with the straight circular waveguide section to the feeder, a threaded connection between the common circular waveguide 116 and the third port is realised in the second part 104 of the unit 100. However other, alternative, methods of connecting the common circular waveguide 116 and the OMT 100 are also possible. Consequently, when using threaded connection, interfacing is simply obtained by screwing the common circular waveguide 116 tube into the thread of the second part and for appropriate sealing at this interface a little portion of glue is distributed in the thread.

In one embodiment the two parts are assembled by screws 150 as can be seen in the Figures. For suitable sealing of the unit, a single closed O-ring can be introduced in a groove 302 between the two parts 102 and 104. In alternative embodiments, however, it is possible to assemble the two parts using other, known in the art, techniques.

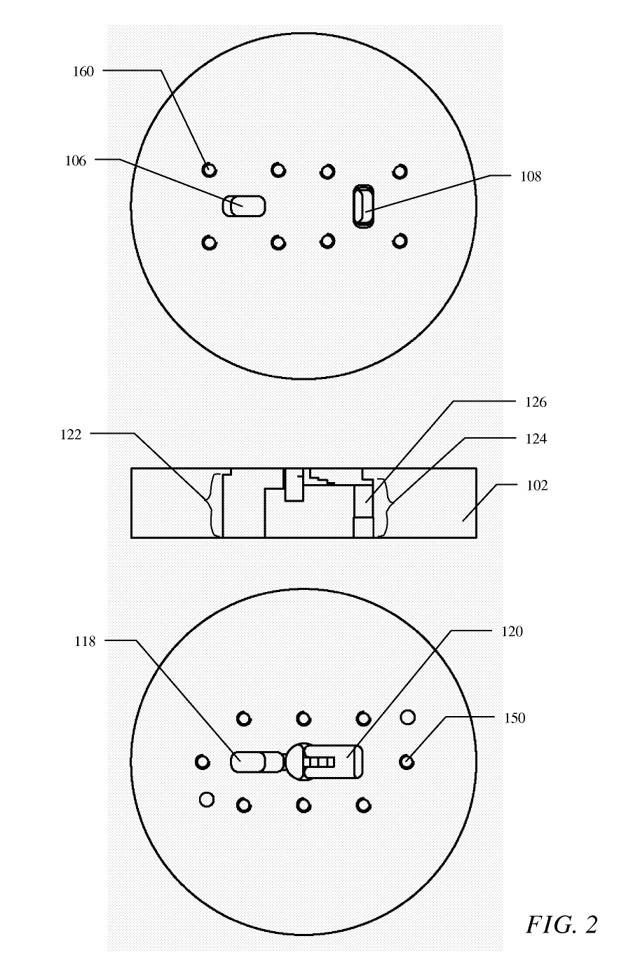

Sealing at the rectangular waveguide interfaces 106, 108 can be realised by O-rings in the respective mating flanges. There is also the possibility to use standard O-ring flange types at the unit itself. In the embodiment illustrated in FIG. 1 and FIG. 2 the rectangular waveguide interfaces 106, 108 have threaded holes 160 for attaching the first and second rectangular waveguides 112 and 114 respectively.

The ortho-mode transducer 100 according to the present invention is preferably manufactured from two blocks of metal in the process of milling it from the flange faces. However it is within the contemplation of the invention that alternative methods of machining can also be used. In principle, the component could easily be manufactured also as diecast from aluminum or even from metallized plastic. In case of milling the junction exhibits some radii in the corners of the cross sections. However, complete rectangular shapes are also possible—that could be a suitable solution for high quantity production by e.g. diecasting with aluminum or silver-plated plastic.

1-6. (canceled)

7. An ortho-mode transducer comprising:
a first part comprising a first rectangular port configured to connect a first rectangular waveguide serving a first linearly polarized signal, and a second rectangular port configured to connect a second rectangular waveguide serving a second linearly polarized signal, wherein the first and second linearly polarized signals have orthogonal polarizations;
a second part comprising a third port configured to connect to a common circular waveguide that propagates the first and second orthogonal, linearly polarized signals;
wherein symmetry axes of respective cross-sections of the first and the second rectangular waveguides have substantially orthogonal orientations;
wherein the first rectangular port comprises broad walls disposed perpendicularly to a circumference of the common circular waveguide;
wherein the second rectangular port comprises broad walls disposed along the circumference of the common circular waveguide;
wherein the first rectangular port connects to the third port via a first 90-degree bend;
wherein the second rectangular port connects to the third port via a second 90-degree bend; and
a coupling region comprising a separating plate extending from a wall closing the common circular waveguide, wherein the separating plate is oriented perpendicularly to longitudinal axes of at least a part of the first and second rectangular ports coupled to the common circular waveguide.

8. The ortho-mode transducer of claim 7 wherein at least one of the first and second 90-degree bends comprises a stepped bend.

9. The ortho-mode transducer of claim 7 wherein the separating plate comprises a flat side that faces the first 90-degree bend, and a stepped side that faces the second 90-degree bend.

10. The ortho-mode transducer of claim 7 wherein the common circular waveguide is short circuited at an end close to a junction.

11. The ortho-mode transducer of claim 7 wherein a parting plane bisects the transducer at an upper broad wall at a section of the second port connected to the common circular waveguide.

12. The ortho-mode transducer of claim 7 wherein a parting plane bisects the transducer substantially through a center of a broad wall at a section of the first port connected to the common circular waveguide.
